(19) United States
(12) Patent Application Publication
(10) Pub. No.: US 2014/0263660 A1
(43) Pub. Date: Sep. 18, 2014

(54) Method and Apparatus for Transmitting Multiple Barcodes

(71) Applicant: MOTOROLA MOBILITY LLC, Libertyville, IL (US)

(72) Inventors: Jun Jiang, Lake Zurich, IL (US); Zhiming Zhuang, Kildeer, IL (US)

(73) Assignee: MOTOROLA MOBILITY LLC, Libertyville, IL (US)

(21) Appl. No.: 13/828,464

(22) Filed: Mar. 14, 2013

(51) Int. Cl. G06K 19/06

(52) U.S. Cl. CPC G06K 19/06112; G06K 19/06028
USPC 235/491

(57) ABSTRACT

A method and apparatus for transmitting bitstreams representing a plurality of barcodes includes an electronic device comprising a lighted display modulating a first light source of a first zone of a plurality of individually lighted zones of the lighted display to transmit a first bitstream representing data of a first barcode, and modulating a second light source of a second zone of the plurality of individually lighted zones of the lighted display to transmit a second bitstream, different from the first bitstream, representing data of a second barcode.

### FIELD OF THE DISCLOSURE

The present disclosure relates generally to the operation of electronic devices and more particularly to methods and apparatus that allow electronic devices to transmit multiple barcodes.

### BACKGROUND

Mobile electronic devices continue to evolve through ever-increasing levels of performance and functionality as manufacturers attempt to answer the consumer call for more innovation. One type of functionality for which gains have been realized concerns mobile commerce. Mobile commerce involves the use of mobile electronic devices to acquire goods and services at a point of sale (POS). The processing capabilities of today's mobile devices make them information management tools, and as such, well suited to execute commercial transactions.

The information passed to a retailer at a POS, for example, generally involves numbers. Numbers identify goods (e.g., stock-keeping unit (SKU) codes), purchase prices, account numbers, routing numbers, and coupon codes. Information is received, encoded, and delivered to the retailer by a mobile device to complete a transaction. One method of delivery is the optical transmission of a barcode using pulses of light. Optical transmission has an advantage over radio frequency (RF) transmission in that it is faster by about two orders of magnitude. A disadvantage, however, is that the amount of information that can be encoded into a single barcode is limited by industry standards.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of an electronic device displaying and optically transmitting multiple barcodes in accordance with some embodiments of the present teachings.

FIG. 2 is a block diagram illustrating a control system and display for transmitting multiple barcodes in accordance with some embodiments of the present teachings.

FIG. 3 is a schematic diagram illustrating two types of backlit zones in accordance with some embodiments of the present teachings.

FIG. 4 is a flow diagram illustrating a method for transmitting multiple barcodes in accordance with some embodiments of the present teachings.

FIG. 5 is a schematic diagram illustrating two display orientations and transmission types in accordance with some embodiments of the present teachings.

FIG. 6 is a sequence diagram illustrating three transmission types in accordance with some embodiments of the present teachings.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Generally speaking, pursuant to the various embodiments, the present disclosure provides a method and apparatus for transmitting multiple barcodes from the lighted display of an electronic device. This allows a user the convenience of quickly transmitting data related to a transaction, for example, at a POS. In accordance with the teachings herein, a method performed by an electronic device comprising a lighted display for transmitting bitstreams representing a plurality of barcodes, comprises: modulating a first light source of a first zone of a plurality of individually lighted zones of the lighted display to transmit a first bitstream representing data of a first barcode; and modulating a second light source of a second zone of the plurality of individually lighted zones of the lighted display to transmit a second bitstream, different from the first bitstream, representing data of a second barcode.

Further in accordance with the teachings herein is an apparatus for transmitting data representing multiple barcodes comprising: a display divisible into a first plurality of zones, wherein each zone is illuminatable by an independently controlled light source; and a set of light-source controllers, wherein each light source is coupled to a light-source controller configured to control the light source to create a bitstream representing barcode data. The apparatus also comprises a processing element, coupled to the set of light-source controllers, wherein the processing element is configured to communicate to the light-source controller coupled to each light source data, related to a barcode, to be transmitted from the zone illuminated by the light source.

Also in accordance with the teachings herein is an apparatus for transmitting data representing multiple barcodes comprising: a backlit display subdivided into a plurality of zones, wherein each zone is illuminatable by an independently controlled light source; and a set of light-source controllers, wherein each light source is coupled to a different one of the light-source controllers, which is configured to control the light source to create a bitstream representing barcode data. The apparatus further comprises a processing element, coupled to the set of light-source controllers, wherein the processing elements is configured to communicate to each light-source controller data, related to a barcode, to be transmitted from a zone illuminated by the corresponding light source.

In one embodiment, the apparatus comprises an array of light emitting diodes, which is subdivided into groups of light emitting diodes configured to illuminate the zones. In another embodiment, the array of light emitting diodes is a two dimensional array that spans an area of the display. In a further embodiment, at least one of the zones is configured to display an image of a barcode represented by data being transmitted from the zone.

Referring now to the drawings, and in particular FIG. 1, a schematic diagram of an electronic device 102 (also referred to herein simply as a “device”) displaying and optically transmitting multiple barcodes is shown and indicated generally at 100. Specifically, FIG. 1 shows a smartphone 102 comprising an illuminatable screen 104 configured to transmit and/or display multiple barcodes 106 that are read by a barcode scanner 108. While a smartphone is shown at 102, no such restriction is intended or implied as to the type of device to which these teachings may be applied. Other suitable devices include, but are not limited to: personal digital assistants (PDAs); audio- and video-file players (e.g., MP3 players and iPODs); personal computing devices, such as tablets; and wearable electronic devices, such as devices worn with a wristband. For purposes of these teachings, an electronic device can be any device that comprises an illuminatable display for which the light source can be modulated to transmit multiple barcodes. A “barcode” is defined to be an optical (relating to light) machine-readable representation of data encoded as an image comprising a pattern of light and dark areas. The phrases “transmitting a barcode” and “transmitting a bitstream representing the data of a barcode” are used interchangeably herein and defined to mean modulating a light source so that light emanating from the light source carries the data or information encoded in the barcode image.

Referring to FIG. 2, a control system and display for transmitting multiple barcodes in accordance with embodiments of the present teachings is shown and indicated generally at 200. In one embodiment, system 200 is included within the electronic device 102 to transmit multiple barcodes. As shown, system 200 comprises: a processing element 202, a signal generation module 204, a modulation module 206, a frequency module 208, six random access memory (RAM) locations 210-220, a display controller 222 comprising six input modules 224-234 and six controllers 236-246, and a display 248 subdivided into six backlit zones 250-260.

A limited number of system elements 202-260 are shown at 200 for ease of illustration, but other embodiments may include a lesser or greater number of such elements in the system 200. Moreover, other elements needed for a commercial embodiment of an electronic device that incorporates the control system 200 are omitted from FIG. 2 for clarity in describing the enclosed embodiments.

We now turn to a brief description of the elements within the system 200. In general, the processing element 202, the display controller 222, and the display 248 are configured with functionality in accordance with embodiments of the present disclosure as described in detail below with respect to the remaining FIGS. 3-6. “Adapted,” “operative” or “configured,” as used herein, means that the indicated elements are implemented using one or more hardware devices such as one or more operatively coupled processing cores, memory devices, and interfaces, which may or may not be programmed with software and/or firmware as the means for the indicated elements to implement their desired functionality. Such functionality is supported by the other hardware shown in FIG. 1, including the system elements 204-220, 224-246, and 250-260.

Continuing with the brief description of the system elements shown at 200, as included within an electronic device 102, the processing element 202 comprises the arithmetic logic and control circuitry necessary to perform the digital processing required for the control system 200 to enable the transmission of multiple barcodes from the display 248. For one embodiment, the processing element 202 represents the primary microprocessor of the electronic device 102. For example, the processing element 202 can represent the application processor of a smartphone. In another embodiment, the processing element 202 is an ancillary processor, separate from the central processing unit (CPU), dedicated to providing the processing capability, in whole or in part, needed for the system elements 200 to perform their intended functionality.

In an embodiment, the signal generation module 204, modulation module 206, and frequency module 208 represent logical elements of functionality incorporated within the processing element 202. In separate embodiments, some or all of the modules 204-208 are physically distinct from the processing element 202. In particular, the signal generation module 204 generates from the data stored within a barcode image a code, which in an embodiment is a sequence of binary bits. For example, dark portions of the barcode are associated with the binary symbol “1” while light portions are associated with the binary symbol “0.” It is this code that is transmitted from a backlit zone of the display 248.

The modulation module 206 determines how the light source of the backlit zone transmitting the barcode is modulated. Modulating a light source, as used herein, means to vary the intensity of light emanating from the light source as a function of time for the purpose of conveying information. For an embodiment, determining the modulation comprises determining the type of modulation (e.g., pulse modulation) and the modulation depth. As an example, a square wave is used to modulate the light source. A certain peak current is associated with the binary digit “1” relative to the current associated with the binary digit “0.” Driving the light source with a square wave creates a bitstream comprising pulses of light (a series of abrupt changes in peak light intensity) that carry the information stored within the barcode being transmitted. As used herein, a bitstream is defined as a transmission of a contiguous sequence of binary bits representing a barcode.

The frequency module 208 determines the duration of the pulses. The period of each bit determines the bitrate of the bitstream, which is defined to be the information density of the bitstream or bits per unit time transmitted. The time it takes a light source to transmit a bitstream is inversely proportional to the bitrate of the bitstream.

The six RAM locations 210-220 provide temporary storage of electronic data used in and resulting from the processing of multiple bitstreams representing different barcodes. Specifically, the control system shown at 200 has hardware support for the simultaneous transmission of six barcodes. Alternate embodiments have hardware support for differing numbers of simultaneous transmissions.

The six input modules 224-234 receive the bitstreams representing the multiple barcodes form the processing element 202. Each input module pairs up the one or more bitstreams that represent a specific barcode with the backlit zone that will transmit that barcode. The physical connection can be by means of an interface or a port. For a particular embodiment, the input modules are co-located with the controllers. In one embodiment the processing element 202 sends each bitstream to a particular input module. In another embodiment, the processing element tags each bitstream for identification by its intended input module. The input module then passes the one or more bitstreams representing a barcode, along with control information, to its associated controller. In embodiments for which the backlit zones 250-260 are reconfigurable, some or all (depending on how many zones are needed) of the input modules 224-234 receive data relevant to the reconfiguring of the zones. This data is also received from the processing element 202 and passed by the input modules 224-234 to their associated controllers 236-246.

The six controllers 236-246 (also referred to herein as light-source controllers) are associated with the six input modules 224-234, respectively, and also with the six backlit zones 250-260, respectively, as shown at 200. Each controller comprises the resources and processing ability to control its associated zone along with its light source. For a particular embodiment, a single controller controls the multiple zones. In an embodiment where the light source of the display comprises light-emitting diodes (LEDs), the controllers 236-246 comprise LED drivers that allow the controllers to group the LEDs into zones and control their current, and thus their luminosity, as a function of time to transmit the barcodes.

The display of the electronic device 102 as shown at 248 is subdivided into six individually lighted zones (sometimes referred to herein as “backlit zones” or simply “zones”). The term “individually lighted,” as used herein, refers to the ability of a controller associated with a zone to modulate the light source of that zone independently from the other zones. In an embodiment, the display 248 is a liquid crystal display (LCD) with its light source placed underneath the LCD layer on the backside of the display. This type of display has backlit zones. In an alternative embodiment, the display's light source is located in front of the LCD layer, and the zones are frontlit.

A further description of the individual zones of display 248 is provided with reference to FIG. 3. Shown at 300 are two backlit zones using LEDs as their light source. Specifically, a first type of backlit zone is indicated at 302 that uses edge lighting. An edge-lit or type-1 zone has LEDs placed along one or more of its edges where those edges coincide with the edge of the display 248. As shown at 302, only one edge has LEDs. In an embodiment, a light guide is used to distribute the illumination provided by the LEDs over the area of the zone to provide uniform lighting.

For an embodiment where the zones are reconfigurable, an LED controller can group the LEDs differently than shown. For example, the area of zone 302 may be split into two new zones by grouping the three leftmost and three rightmost LEDs separately. Alternatively, the LEDs shown at 302 can all be grouped together with LEDs of a neighboring zone to make a new zone having a larger size.

Type-2 zones occur when illumination is provided by an array of LEDs uniformly dispersed throughout the area of the display 248. These LEDs can be grouped by one or more controllers on an individual basis to create zones having any size or shape within the display area. A rectangular type-2 zone is shown at 304, which may take on a square, trapezoidal, or triangular shape, for example, in other embodiments. Further, when the display comprises an array of light-emitting diodes, which can be grouped into the individually controlled light sources, it can be subdivided into the exact number of zones needed to transmit a specific multiple of barcodes. In another embodiment, backlighting for type-2 zones is provided by organic light-emitting diodes (OLEDs).

We turn now to a detailed description of the functionality of the elements shown in FIGS. 1-3 at 100-300, respectively, in accordance with the teachings herein and by reference to the remaining figures. FIG. 4 is a logical flow diagram illustrating a method 400 for transmitting multiple barcodes in accordance with some embodiments of the present teachings. Each barcode is optically transmitted from an independently illuminatable zone as a bitstream. In an embodiment, at least one zone is configured to display an image of a barcode represented by data transmitted from the zone.

Displaying the image of a barcode allows it to be read by a barcode image reader at a POS. Barcode image readers include charge-coupled device (CCD) readers and camera-based readers. These types of readers process a captured image of the barcode to extract its encoded information.

A barcode scanner, such as a laser scanner, is equipped with an infrared laser and a photodiode that detects reflected light. As the laser is scanned across the barcode at a constant rate, the darker areas of lower reflectivity within the barcode cause breaks in the reflected light detected at the photodiode. The duration of these breaks are proportional to the widths of the dark bands, causing a series of light pulses that coincide with the times the laser is incident upon an area between the dark bands of relatively higher reflectivity.

The series of light pulses recorded by the laser scanner are simulated by the electronic device 102 modulating the light source of an individual zone to transmit a barcode. This allows a barcode laser scanner, for example, to “see” the barcode without the device 102 actually having to display the image of the barcode. This feature lends itself to a new generation of barcode scanners that will not need to be equipped with a light source. The new scanners will simply detect the light flashes emanating from the backlit zones of device 102.

At 402, in an embodiment where the display 248 comprises reconfigurable zones, the electronic device 102 divides or configures the area of its lighted display into a plurality of individually lighted zones. For other embodiments, the electronic device 102 is manufactured with a fixed number of preconfigured zones. With preconfigured zones, the electronic device 102 has the ability to simultaneously transmit as many (or less) barcodes as it has zones, namely, one from each zone. Reconfiguring the zones of the display from a first plurality of zones into a second plurality of zones is advantageous if, since the last transmission, a different number of barcodes are to be transmitted or differently sized barcodes are to be displayed.

In an embodiment wherein the subdivided display 248 is reconfigurable from a first plurality of zones into a second plurality of zones, the difference between the first and second plurality of zones comprises at least one of: a difference in number of zones, a difference in dimension of zones, or a difference in arrangement of zones. If, for example, the display 248 is configured for two zones and three barcodes need to be transmitted, the display is simply reconfigured into three zones by changing the grouping of the LEDs as indicated by reference to FIG. 3.

If the electronic device 102 is also to display an image of one or more barcodes being transmitted, in at least one embodiment, the dimensions of one or more zones are changed to match the physical characteristics of the displayed barcodes. In one particular embodiment with a very long barcode, at least one zone is configured to display the image of the barcode diagonally across the display 248. For a square or rectangular display, a diagonal zone that connects the corners across opposite sides of the display represents the longest possible zone. In two additional embodiments, the display is subdivided into a plurality of vertically stacked zones in a portrait orientation or the display is subdivided into a plurality of vertically stacked zones in a landscape orientation. These embodiments are illustrated in FIGS. 5 at 502 and 504, respectively. The portrait orientation 502, which is also shown in FIG. 1 at 100, is ideal when a larger number or shorter barcodes are displayed relative to the landscape orientation 504, which is better suited for a smaller number of longer barcodes.

It is also possible to reconfigure the zones of display 248 such that the same zones are simply arranged differently. For example, in a first arrangement, a first zone covers the upper half of the display 248 while a second and a third zone each occupy opposite sides of the lower half of the display 248. In a second arrangement, the first zone covers the lower half of the display 248 while the second and the third zone each occupy opposite sides of the upper half of the display 248.

At 404, the electronic device 102 sends data representing multiple barcodes to a set of light-source controllers coupled to the independently controlled light sources of their associated zones. As defined herein, a “set” can contain a single or multiple elements. In one embodiment, data for the bar codes, prior to it being processed by system 200 elements 202-208, originates from outside the device 102. For example, banking data is received by the device 102 at a POS via a network connection. Information regarding a user's debit account is then processed into one or more binary sequences representing one or more barcodes which are sent, along with modulation and frequency information, to one or more light-source controllers within the display controller 222. In another embodiment, data for the bar codes is already stored on the device 102 at a time of sale. In a first example, data representing redeemable coupons downloaded during a previous transaction is retrieved from a memory of the device 102 during the current transaction and processed by system 200 elements 202-208 into multiple binary sequences that each represent a barcode. In a second example, a user of a smartphone equipped with a camera capable of scanning printed barcodes and quick response (QR) codes does so (e.g., for published coupons) and stores the data until needed at a POS.

At 406, each light source controller of the set of light source controllers modulates the light source of its associated zone to transmit a bitstream representing a barcode of the multiple barcodes from that zone. For some embodiments, the transmission of the bitstream is repeated a certain number of times or for a particular duration of time.

Turning momentarily to FIG. 5, two types of repeating transmissions are shown, a fixed bitrate transmission at 506 and a variable bitrate transmission at 508. These transmissions represent a first and second barcode being transmitted from a first (upper) and second (lower) zone, respectively, of the lighted display 248 shown in portrait orientation at 502. Separately modulating a first (upper) and second (lower) light source to transmit the first and second bitstreams, respectively, comprises pulsing light originating from the first and second light sources to encode the first and second bitstreams. The purpose of repeating the transmission of a bitstream is to increase the likelihood that a barcode scanner will successfully read the barcode.

For one embodiment, the second light source of the second zone is modulated to transmit a third bitstream representing data of the second barcode, wherein the second and third bitstreams are transmitted at different times and at different bitrates. This embodiment is shown at 508. The transmission of the second barcode is repeated using a bitstream having a lower bitrate (a longer period per bit) for the benefit of older scanners with limited capabilities. For example, the period per bit (PPB) of the first bitstream of the variable bitrate transmission (VBT) 508 is 1 microsecond (μs), the PPB of the second bitstream of the VBT 508 is 2 μs, and the PPB of third bitstream (not shown) of the VBT 508 is 5 μs. A newer scanner capable of a PPB of 0.1 μs easily reads the second barcode from the first bitstream. An older scanner only capable of a PPB of 1.5 μs waits to read the second bitstream of the VBT 508, with the third being provided as a failsafe. The first, second and third bitstreams of the VBT then repeat for a given duration of time, or in the alternative, until a confirmation of a successful read is received from the barcode scanner. In an embodiment, the electronic device 102 receives confirmation from the barcode scanner as a near-field communication (NFC).

For another embodiment, the electronic device 102 and a barcode scanner use NFC to synchronize with each other (perform a handshake), after which the electronic device 102 knows the scanner's capability and the scanner knows at which bitrate the electronic device 102 will be transmitting. The electronic device 102 then repeats the same bitstream, as shown at 506, in a fixed bitrate transmission.

In a further embodiment, the second barcode is identical to the first barcode, and the second bitstream is transmitted at a lower bitrate than the first bitstream. Transmitting the same barcode from different zones at different frequencies allows future scanners, capable of simultaneously scanning the entire display 248, to select the transmission it can read best.

Returning to FIG. 4, the electronic device 102 optionally, at 408, displays in one or more zones an image of the barcode being transmitted from the zone. As previously indicated, this allows the barcode to be read by both scanners and image-capturing devices. It also allows a user or cashier to make a visual inspection of the barcode at a POS. In an embodiment, the image is created by polarizing areas of the LCD portion of display 248 that coincide with the dark areas of the barcode so as to block the backlighting. The remaining areas of the zone which are darkened, allow sufficient light to emanate from the zone to enable the modulated light to be registered by the barcode scanner. In an embodiment, the current of the LEDs is 20 milliamps during a pulse, while the detection threshold for the barcode scanner is just 3 milliamps. Even with 50% of the light emanating from a zone blocked by the LCD image, the scanner is still able to read the barcode from the modulated light.

FIG. 6 is a sequence diagram illustrating three additional transmission types at 600 in accordance with some embodiments of the present teachings. More particularly, FIG. 6 defines a transmission of a first bitstream, representing a barcode A, from a first zone in terms of its temporal relation to a transmission of a second bitstream, representing a barcode B, from a second zone. At 602, transmission of the first bitstream and transmission of the second bitstream is synchronous in time, meaning that the bit streams are time-aligned and overlapping in time. For other embodiments, synchronous transmission is maintained for more than two barcodes. This format aids some types of scanners and works best if the individual bitstreams representing the multiple barcodes are all of similar length as shown at 602.

At 604, transmission of the first bitstream and transmission of the second bitstream is asynchronous in time, meaning that the bit streams are not time-aligned but are overlapping in time. For embodiments in which the multiple barcodes are represented by bitstreams having widely varying lengths, asynchronous transmission is more time efficient than synchronous transmission. Because the bitstreams of separate transmissions are no longer aligned, the transmission comprising the shorter bitstreams is not held up as a longer bitstream finishes transmitting.

At 606, transmission of the first bitstream and transmission of the second bitstream are staggered in time such that the first bitstream and the second bitstream are non-overlapping in time. In other embodiments, this transmission scheme is also extended to more than two barcodes. Staggered transmission allows for only one bitstream to be transmitting at any given time. The advantage of this transmission format for some scanners is that light from one zone is not a source of interference as the scanner is reading the barcode of another zone.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method, performed by an electronic device comprising a lighted display, for transmitting bitstreams representing a plurality of barcodes, the method comprising:
modulating a first light source of a first zone of a plurality of individually lighted zones of the lighted display to transmit a first bitstream representing data of a first barcode; and
modulating a second light source of a second zone of the plurality of individually lighted zones of the lighted display to transmit a second bitstream, different from the first bitstream, representing data of a second barcode.

2. The method of claim 1 further comprising dividing an area of the lighted display into the plurality of individually lighted zones.

3. The method of claim 1, wherein modulating the first and second light sources to transmit the first and second bitstreams comprises pulsing light originating from the first and second light sources to encode the first and second bitstreams.

4. The method of claim 1, wherein the second barcode is identical to the first barcode, and wherein the second bitstream is transmitted at a lower bitrate than the first bitstream.

5. The method of claim 1 further comprising modulating the first light source of the first zone to transmit a third bitstream representing data of the first barcode, wherein the first and third bitstreams are transmitted at different times and at different bitrates.

6. The method of claim 1, wherein transmission of the first bitstream and transmission of the second bitstream is synchronous in time.

7. The method of claim 1, wherein transmission of the first bitstream and transmission of the second bitstream is asynchronous in time.

8. The method of claim 1, wherein transmission of the first bitstream and transmission of the second bitstream are staggered in time such that the first bitstream and the second bitstream are non-overlapping in time.

9. The method of claim 1 further comprising displaying at least one of an image of the first barcode in the first zone or an image of the second bar code in the second zone.

10. An apparatus for transmitting data representing multiple barcodes, the apparatus comprising:
a display divisible into a first plurality of zones, wherein each zone is illuminatable by an independently controlled light source;
a set of light-source controllers, wherein each light source is coupled to a light-source controller configured to control the light source to create a bitstream representing barcode data; and
a processing element, coupled to the set of light-source controllers, wherein the processing element is configured to communicate to the light-source controller coupled to each light source data, related to a barcode, to be transmitted from the zone illuminated by the light source.

11. The apparatus of claim 10, wherein the subdivided display is reconfigurable into a second plurality of zones, where a difference between the first plurality of zones and the second plurality of zones comprises at least one of:
a difference in number of zones;
a difference in dimension of zones; or
a difference in arrangement of zones.

12. The apparatus of claim 11, wherein the display comprises an array of light-emitting diodes, which can be grouped into the individually controlled light sources.

13. The apparatus of claim 10, wherein at least one zone is configured to display an image of a barcode represented by data transmitted from the zone.

14. The apparatus of claim 13, wherein the at least one zone is configured to display the image of the barcode diagonally across the display.

15. The apparatus of claim 10, wherein the display is subdivided into a plurality of vertically stacked zones in a portrait orientation.

16. The apparatus of claim 10, wherein the display is subdivided into a plurality of vertically stacked zones in a landscape orientation.

17. An apparatus for transmitting data representing multiple barcodes, the apparatus comprising:
a backlit display subdivided into a plurality of zones, wherein each zone is illuminatable by an independently controlled light source;
a set of light-source controllers, wherein each light source is coupled to a different one of the light-source controllers, which is configured to control the light source to create a bitstream representing barcode data; and
a processing element, coupled to the set of light-source controllers, wherein the processing elements is configured to communicate to each light-source controller data, related to a barcode, to be transmitted from a zone illuminated by the corresponding light source.

18. The apparatus of claim 17, further comprising an array of light emitting diodes, which is subdivided into groups of light emitting diodes configured to illuminate the zones.

19. The apparatus of claim 18, wherein the array of light emitting diodes is a two-dimensional array that spans an area of the display.

20. The apparatus of claim 17, wherein at least one of the zones is configured to display an image of a barcode represented by data being transmitted from the zone.
